(19) United States
(12) Patent Application Publication
(10) Pub. No.: US 2022/0372804 A1
(43) Pub. Date: Nov. 24, 2022

(54) RAPID DOOR LATCHING DEVICE

(71) Applicant: Tony R. Sloat, JR., Centralia, IL (US)

(72) Inventor: Tony R. Sloat, JR., Centralia, IL (US)

(21) Appl. No.: 17/693,284

(22) Filed: Mar. 11, 2022

Related U.S. Application Data
(60) Provisional application No. 63/159,991, filed on Mar. 11, 2021.

(51) Int. Cl. E05C 19/12

(52) U.S. Cl. CPC E05C 19/12

(57) ABSTRACT

The present invention is directed to a door latching device that can be deployed in emergency situations to lock down a classroom, business, church, home or any other building. The device comprises a backing plate, a hinge body, a jamb hook and a hinge shaft that can pivot, thereby moving the jamb hook from a stored position to a latched position and vice versa. When the device is in a latched position, the device prevents a door from opening. The device can be moved from the stored position to a latched position, and conversely from the latched position to the stored position, with the use of only one hand and without the use of a specialized key.

### RELATED PATENT APPLICATIONS AND INCORPORATION BY REFERENCE

This application claims priority to U.S. Provisional Patent Application Ser. No. 63/159,991, filed on Mar. 11, 2021, the disclosure of which is hereby incorporated by reference in its entirety.

### STATEMENT REGARDING FEDERALLY SPONSORED RESEARCH OR DEVELOPMENT

The present invention was made with no governmental support.

### FIELD OF THE INVENTION

The present invention relates generally to door anti-latch devices and, more particularly, to a door anti-latch device that allows for keyless, quick and easy deployment in emergency situations.

### BACKGROUND OF THE INVENTION

Since the start of the 21^{st} century, there have been over thirteen incidents in the United States of intruders entering schools and causing over fifty deaths and injury to over eighty others. The number of deaths from school shootings in the first twenty years of the 21^{st} century exceeds the total number of deaths from school shootings in the whole 20^{th} century. School shootings in the United States are thus a very serious concern and there is a need for improved emergency procedures and systems to protect the safety of students and teachers across the country.

When a school is under threat from an intruder, it is imperative that classrooms quickly go into lockdown mode. In such emergency situations, the difference between life and death may be the ability to lockdown a classroom immediately upon detection of a threat from an intruder. Until recently, state laws and safety codes prohibited the use of temporary door locking devices. However, as of late, several states have adopted amendments to codes that allow for emergency door latch devices to be used in schools.

Often schools have classroom doors that are not equipped for quick lockdown. In many schools, doors only lock with a key from the outside hallway side of the door. Doors of this type compromise the teacher's safety and slow the process of lockdown by causing the wasting of valuable time while the teacher searches for a key. Even worse, some schools have doors with no locks at all.

For schools that have lockable doors in place, the locking hardware may prove to be too cost prohibitive to outfit all of the doors in the school. For example, solutions such as electronically controlled, wireless and keyless door locks that can be activated by a remote key fob or centralized lockdown hardware integrated with access control software may cost thousands of dollars per door.

Many known door locking devices may also increase risk by violating fire and life safety codes. Locking devices for school doors must be arranged to allow for the door to be readily opened from the inside of the classroom. Further, classroom doors must be able to be opened from the inside of the classroom without use of a key or special knowledge or effort.

Because the known technologies often do not produce adequate security and, even worse, sometimes create safety risks and/or do not comply with applicable safety codes, there is a need for a more effective and legally compliant classroom door latching device.

### SUMMARY OF THE INVENTION

In view of the shortcomings of the prior art, it is an object of the present invention to provide a more effective, more cost effective and legally compliant classroom door latching device. Other objects and features of the invention will be in part apparent and in part specifically described herein.

In accordance with the present invention, there is provided a door latching device comprising a backing plate and hinge body, which secure the device to a door, and a jamb hook and a hinge shaft assembly wherein the hinge shaft can pivot, thereby moving the jamb hook from an unlatched position to a latched position and vice versa.

### BRIEF DESCRIPTION OF THE DRAWINGS

FIG. 1 illustrates a bottom view of an embodiment of the present invention mounted upon a door.

FIG. 2 illustrates a front view of an embodiment of the present invention mounted upon a door.

FIG. 3 illustrates a side view of an embodiment of the present invention.

FIG. 4 illustrates a front view of a backing plate of an embodiment of the present invention.

FIG. 5 illustrates a front view of a hinge body of the present invention.

FIG. 6 illustrates a hinge shaft of an embodiment of the present invention.

FIG. 7 illustrates a jamb hook of an embodiment of the present invention.

FIG. 8 illustrates a top view of a jamb hook of an embodiment of the present invention.

FIG. 9 illustrates a top view of a hinge body of an embodiment of the present invention.

FIG. 10 is a photographic image of a front view of an embodiment of the present invention.

FIG. 11 is a photographic image of a rear view of an embodiment of the present invention.

FIG. 12 is a photographic image of a set of jamb hook bolts employed to secure the jamb hook to the hinge shaft of an embodiment of the present invention.

FIG. 13 is a photographic image of a set of bolts employed to secure the device of the present invention to a door.

FIG. 14 is a photographic image of a front view of a backing plate of an embodiment of the present invention.

FIG. 15 is a photographic image of a perspective view of a jamb hook of an embodiment of the present invention.

FIG. 16 is a photographic image of a perspective view of a hinge shaft of an embodiment of the present invention.

FIG. 17 is a photographic image of a perspective view of a hinge body of an embodiment of the present invention.

FIG. 18 is a photographic image of a front view of an embodiment of the present invention.

FIG. 19 is a photographic image of a perspective view of an embodiment of the present invention installed and mounted on a door.

FIG. 20 is a series of photographic images showing an embodiment of the present invention in an unlatched position, a latched position and showing the backing plate of the present invention secured to a door.

### DETAILED DESCRIPTION

The following detailed description is merely exemplary in nature and is not intended to and should not be interpreted to limit the embodiments described herein. Although particular embodiments are described, those embodiments are merely exemplary implementations of the system of the present invention. The following descriptions and illustrations herein should be considered illustrative in nature, and thus, not in any way limiting the scope of the present invention. One skilled in the art will recognize other embodiments are possible and all such embodiments are intended to fall within the scope of the present disclosure. While the preferred embodiments are described with reference to the above drawings, there is no intent to limit the disclosure to the embodiments shown in the drawings or disclosed herein. Rather, the intent is to include all alternatives, modifications and equivalents that embody the spirit and scope of the disclosure.

It is also to be understood that the disclosure uses terminology for the purpose of describing particular embodiments and such terminology is not intended to be limiting.

Unless defined otherwise, all technical and scientific terms used in this disclosure have the same meaning as commonly understood by one of ordinary skill in the art to which is applicable to this disclosure.

As will be apparent to those of skill in the art upon reading this disclosure, each of the embodiments described and illustrated herein has discrete components and features which may be readily separated or combined with features of any of the other possible embodiments without departing from the spirit and scope of the present disclosure.

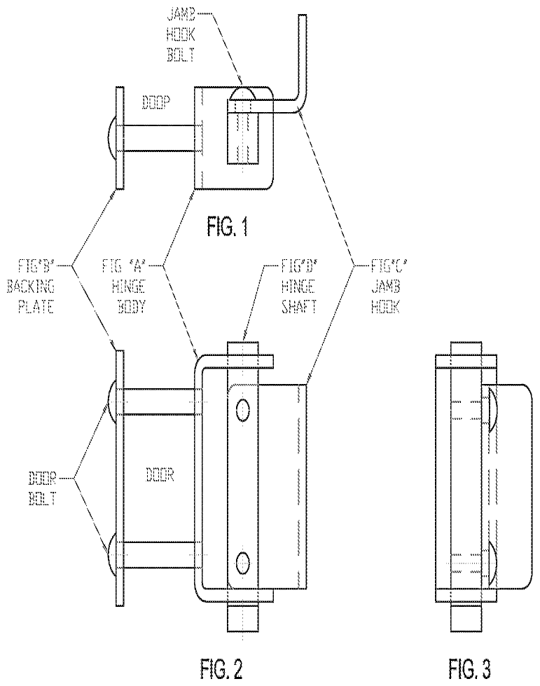

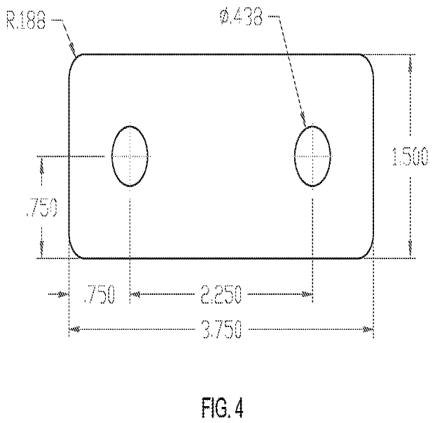

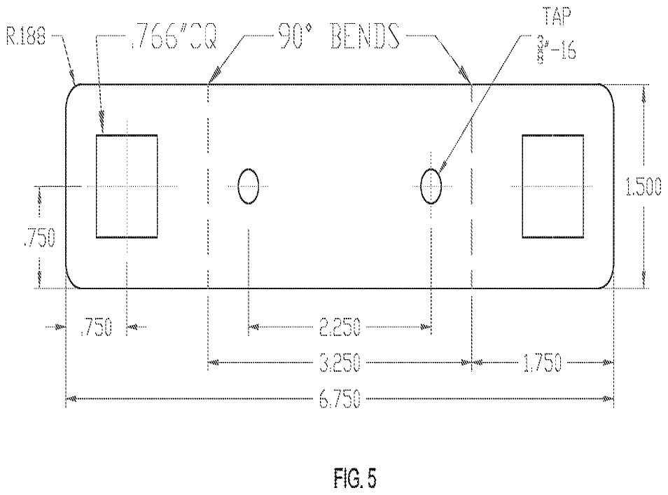

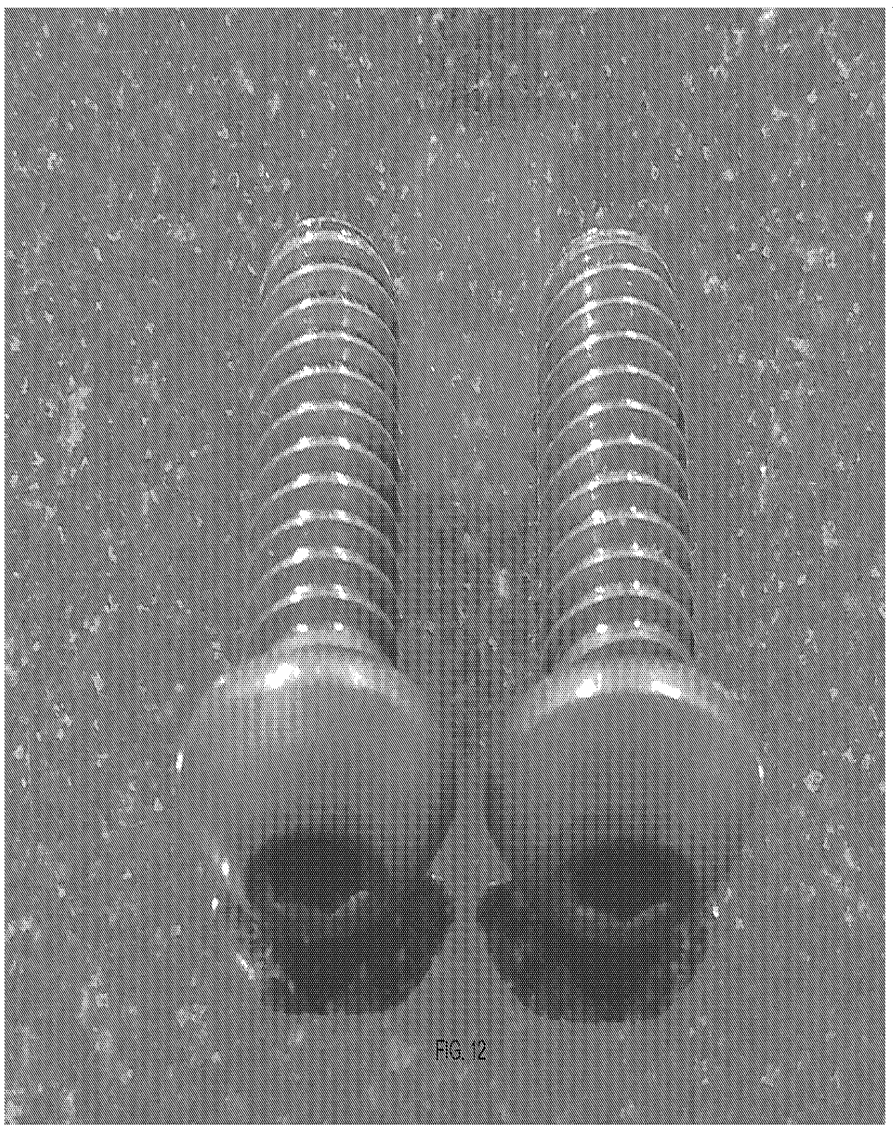

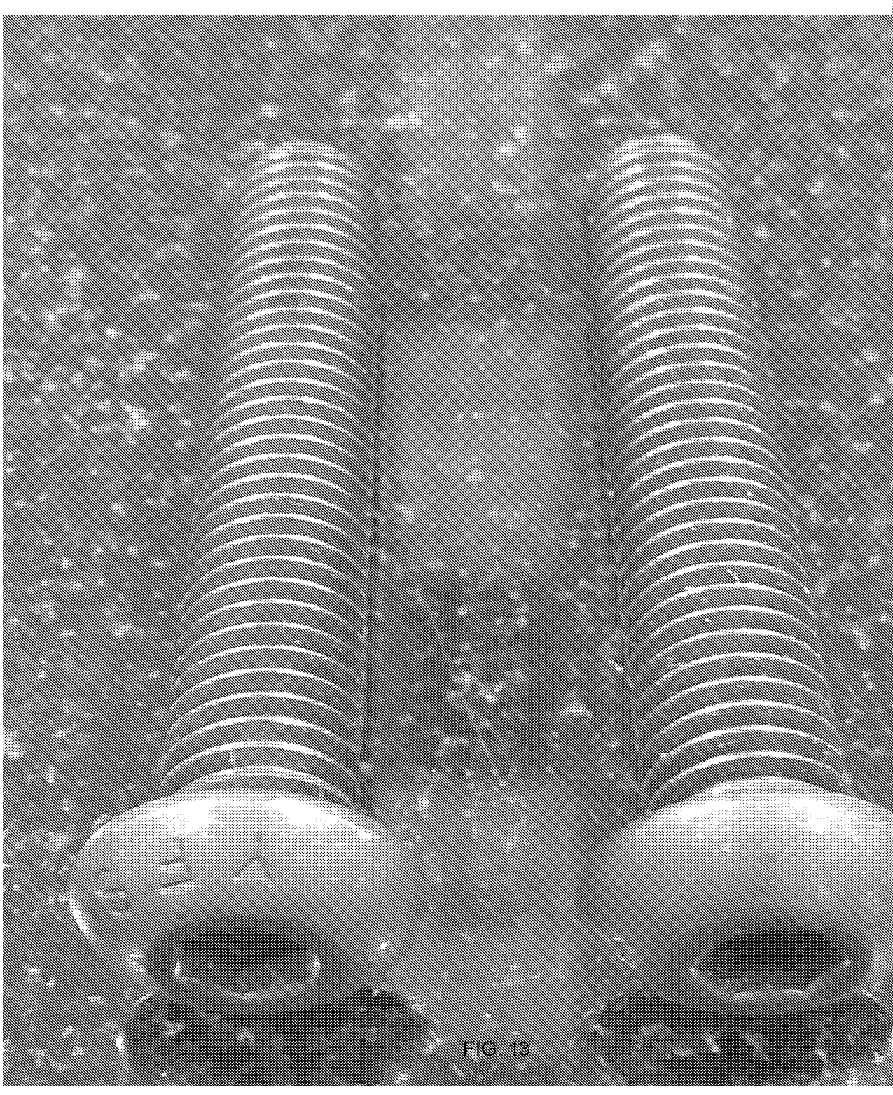

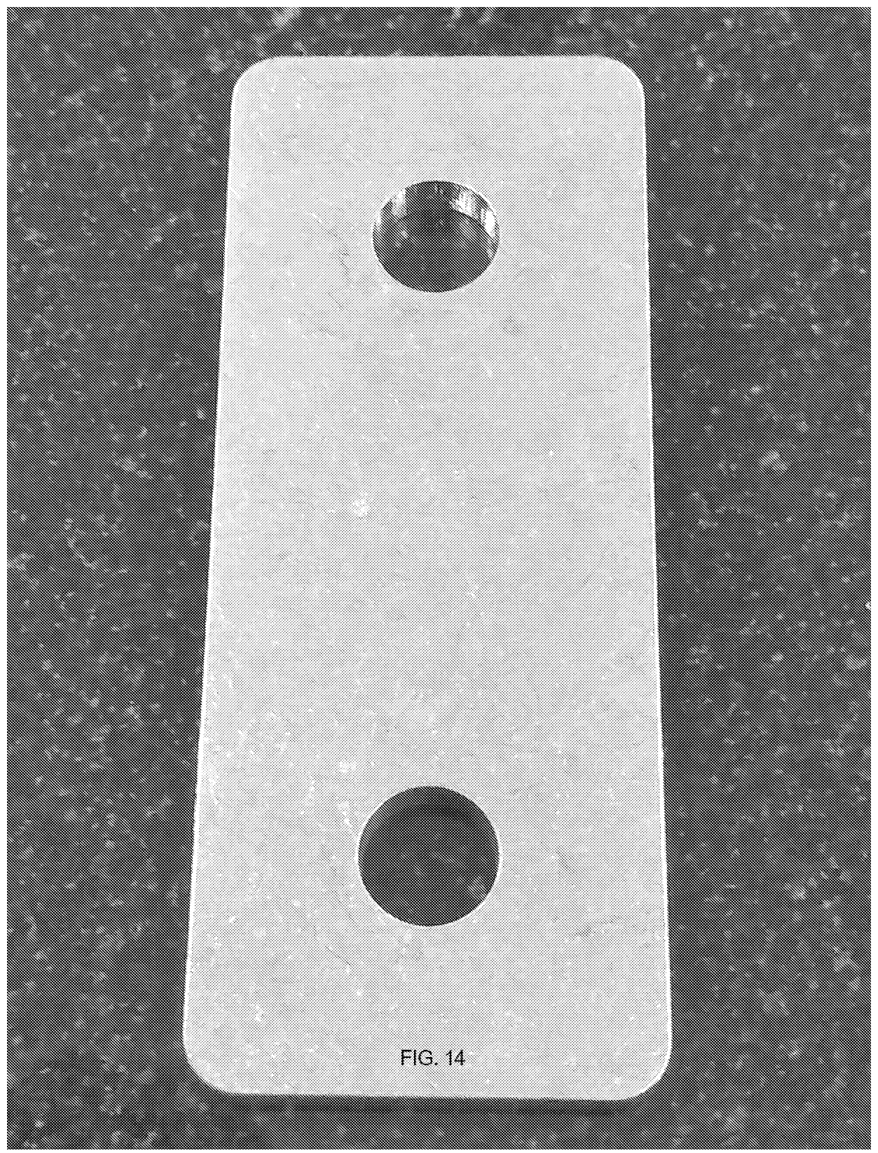

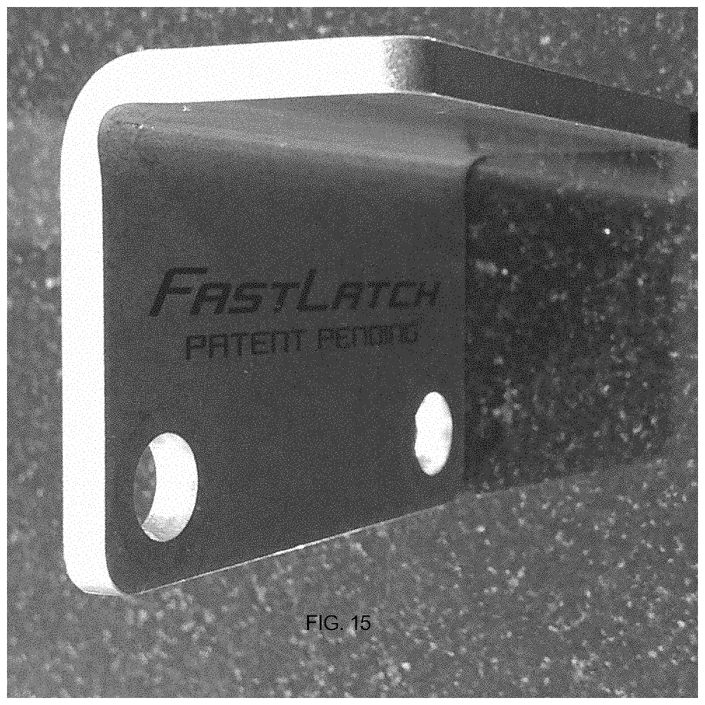

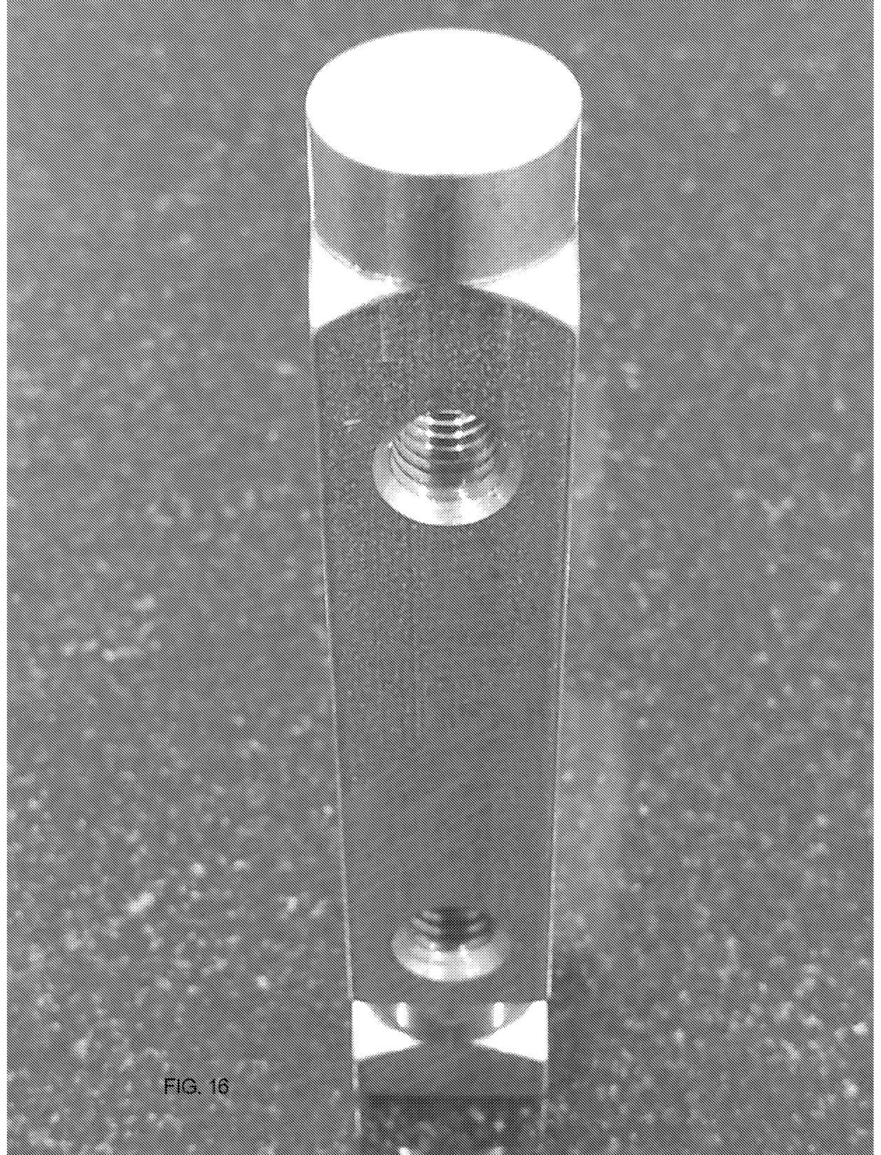

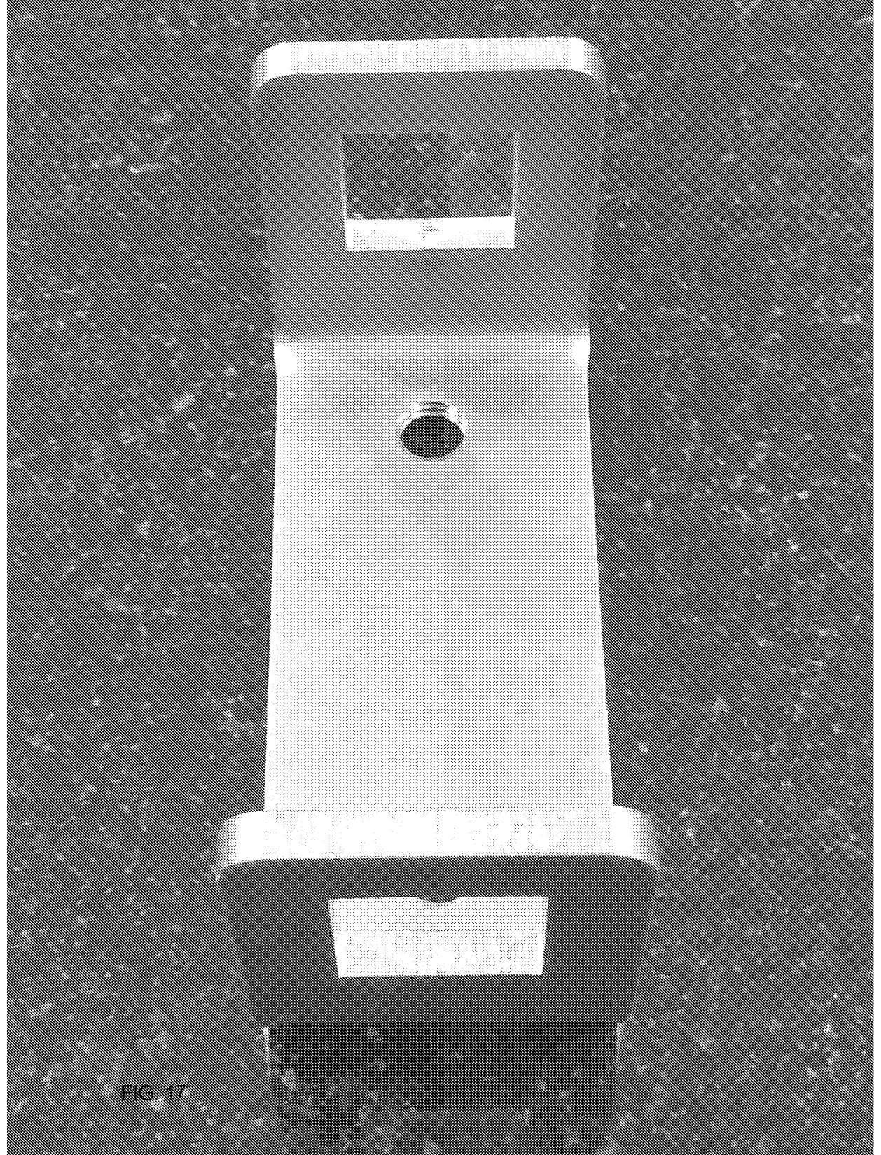

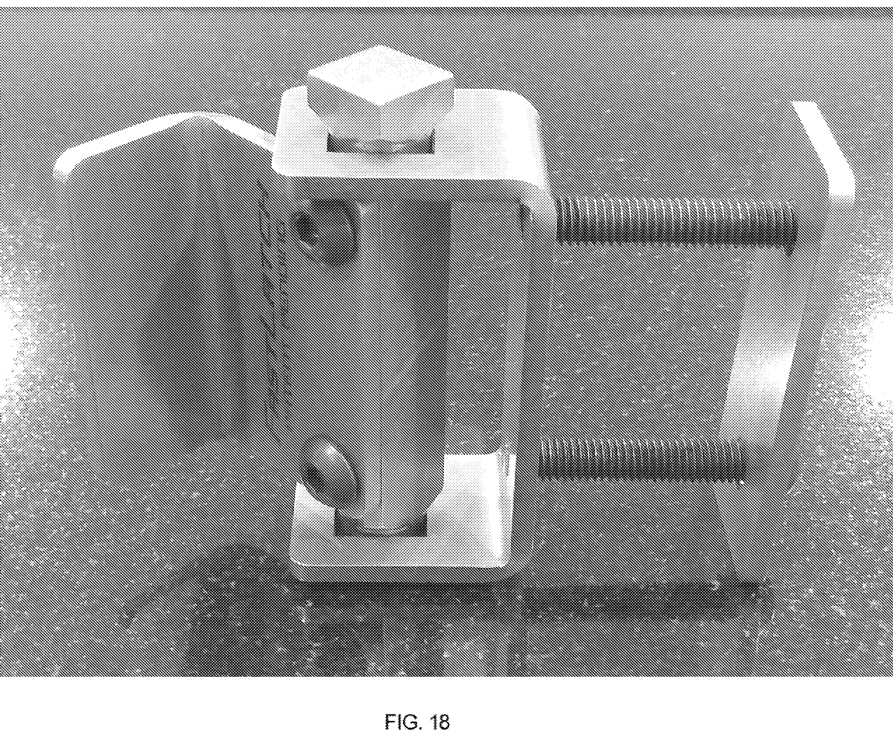

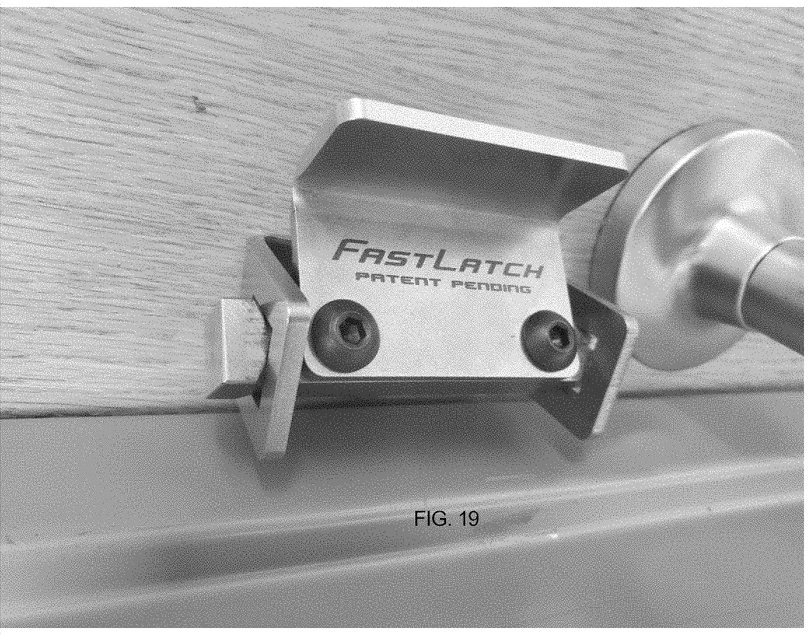

Referring now to the invention in more detail, in FIGS. 1-3, 10, 11 and 18, there is shown a preferred embodiment of the present invention. As can be seen in FIGS. 1 and 2, the door latching device 1 of the present invention comprises a backing plate 2, a hinge body 3, a hinge shaft 4 and a jamb hook 5, as well as mounting hardware comprising preferably metal bolts 6, 7.

As further illustrated in FIGS. 1 and 2, the door latching device 1 of the present invention is mounted upon a door 10 by virtue of two bolts 6, 7 that are inserted through holes 8, 9 in the backing plate 2 and further inserted through corresponding holes that are drilled into a door 10. As also shown in FIGS. 1 and 2, the bolts 6, 7 are securely threaded through two mounting holes 23, 24 of the hinge body 3 and through corresponding holes 8, 9 of the backing plate, thus securing both the backing plate 2 and the hinge body 3 flush against opposing sides of the door 10. As shown in FIGS. 1 and 2, the backing plate 2 is secured to the outer side 11 (i.e., hallway side) of a door 10, while the hinge body 3 is secured to the inner side 12 (i.e., classroom side) of the door 10. Although it is preferred to use bolts 6, 7 to mount the backing plate 2 and the hinge body 3 to the door 10, any other suitable means known in the art may be employed to secure the backing plate 2 and the hinge body 3 to the door 10.

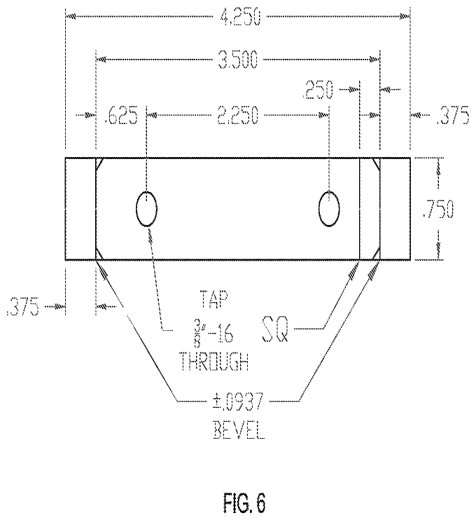

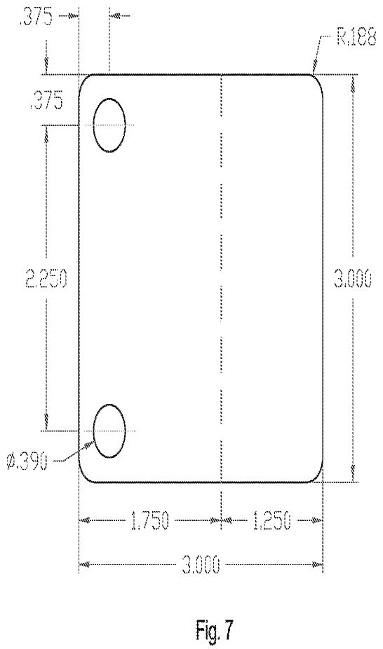

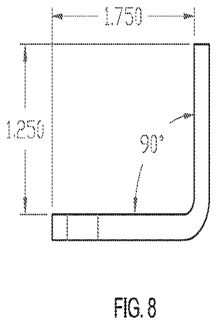

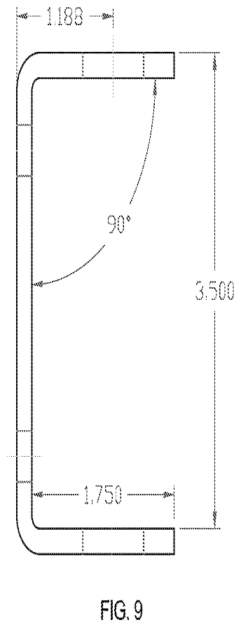

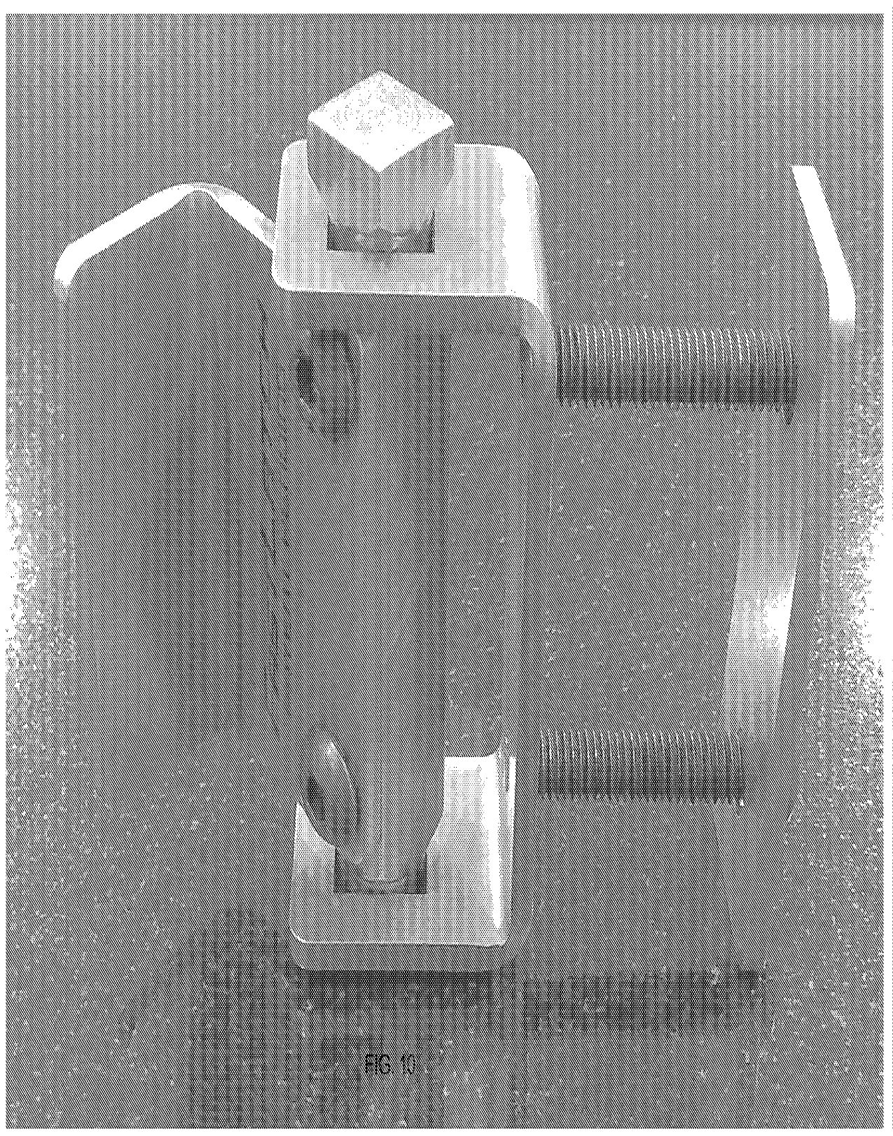

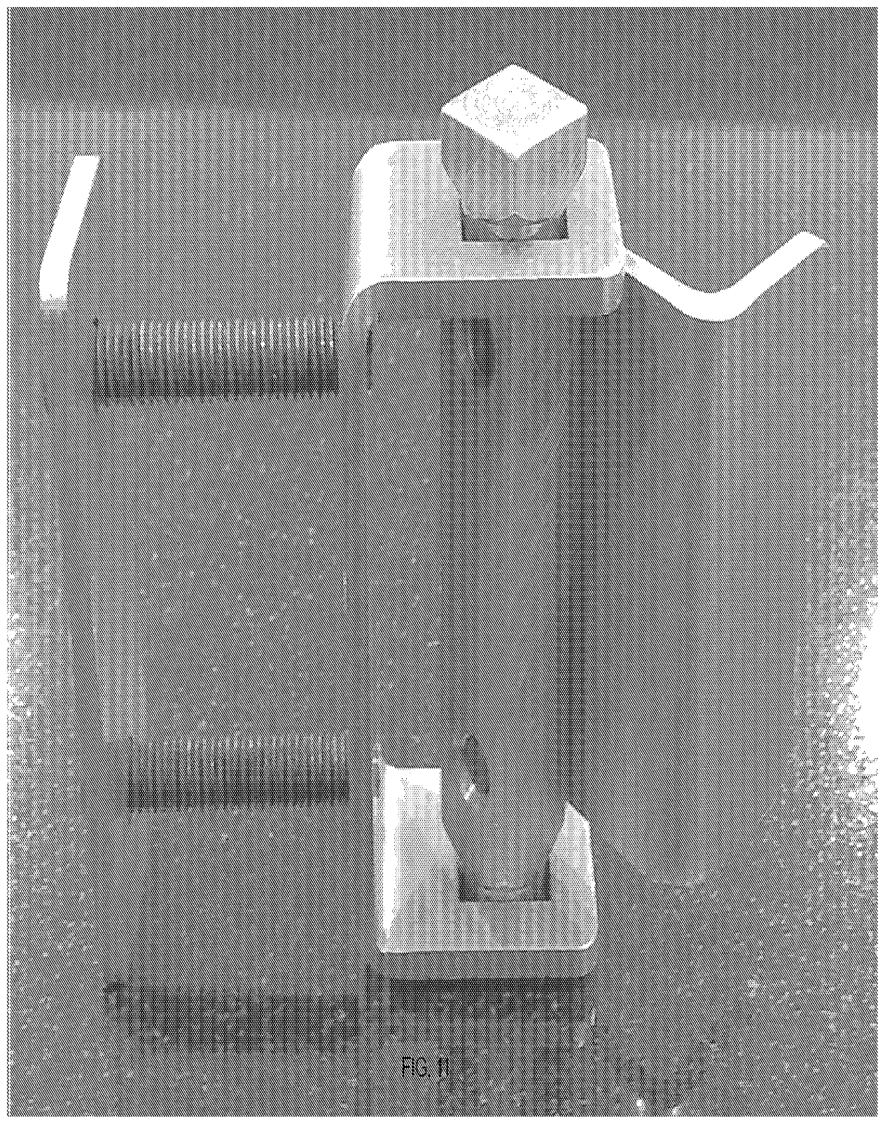

A hinge shaft 4 (shown in FIG. 6) is rotatably positioned through two opposing apertures 21, 22 in the hinge body 3, as shown in FIGS. 1, 2 and 18. As seen in FIG. 10, the jamb hook 5 is secured to the rotatable hinge shaft 4 by way of bolts 13, 14 that are preferably threaded through holes 15, 16 in the jamb hook 5 and further threaded into corresponding holes 19, 20 in the hinge shaft 4. The holes 15, 16 in the jamb hook 5 are illustrated in FIG. 7. This design of the jamb hook 5 and hinge shaft assembly is preferred for ease of manufacture and assembly, however any other suitable means known in the art may be used to securely affix the jamb hook 5 to the hinge shaft 4.

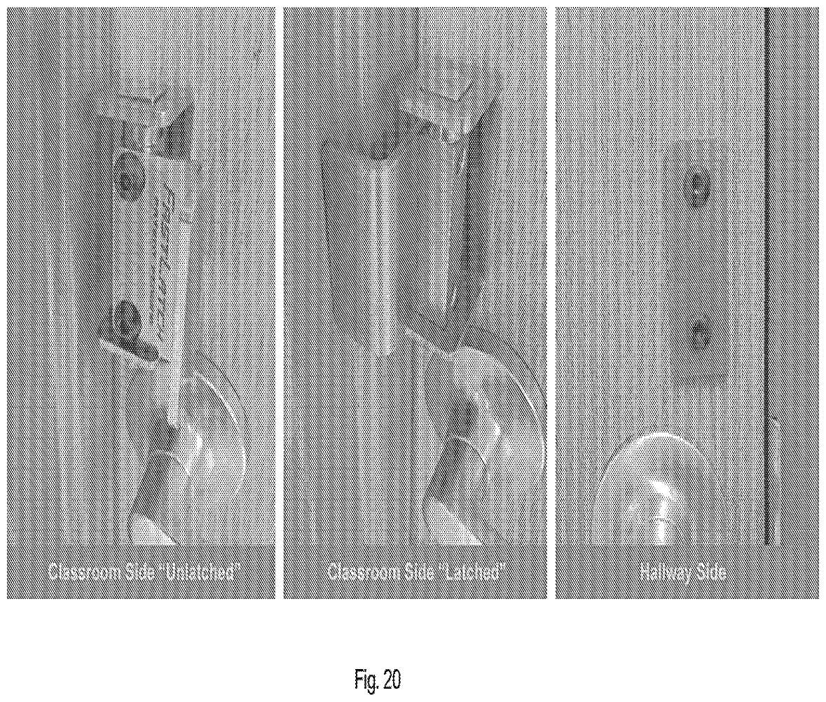

When the door latching device 1 of the present invention is in an unlatched position, as shown in FIG. 20, the jamb hook 5 is free from the door jamb 25 and the act of opening the door 10 is not in any way precluded or impeded by the door latching device 1. The position of the jamb hook 5 may be quickly and easily rotated by a user's single hand, thus rendering the invention in a latched position, as shown in FIG. 20. This latching or locking action is achieved by the user pivoting the hinge shaft 4 roughly 90 degrees toward the door jamb 25. Once in the latched or locked position, the jamb hook 5 abuts the door jamb 25 and prevents the door 10 from opening. The user may, likewise using one hand, easily return the jamb hook 5 to the unlatched or unlocked position, as shown in FIG. 20, thereby once again allowing the door 10 to be freely opened.

Having described the preferred embodiment of the present invention, any number of changes, variations and improvements which may be apparent to those skilled in the art are within the scope of the invention claimed and described herein.

What is claimed is:

1. A door latching device comprising:
A backing plate;
A hinge body;
A hinge shaft; and
A jamb hook;
Wherein said backing plate and said hinge body are secured to opposite sides of a door;
Said hinge shaft is rotatably supported in the hinge body;
and said jamb hook is fixedly attached to said hinge body and may be rotated into a locked position abutting a door jamb and preventing said door from being opened.

2. A door latching device according to claim 1, wherein said backing plate and said hinge body are secured to the door by bolts.
